(19) United States
(12) Patent Application Publication
(10) Pub. No.: US 2016/0260065 A1
(43) Pub. Date: Sep. 8, 2016

(54) DEPOSITION AUTOMATION SYSTEM AND METHOD

(71) Applicant: SmartDepo, LLC, Atlanta, GA (US)

(72) Inventors: Alexander J. Gallo, Atlanta, GA (US); Willem A. Robberts, Tiburon, CA (US)

(21) Appl. No.: 15/060,985

(22) Filed: Mar. 4, 2016

Related U.S. Application Data
(60) Provisional application No. 62/129,173, filed on Mar. 6, 2015.

(51) Int. Cl. G06Q 10/10; H04W 4/02

(52) U.S. Cl. CPC G06Q 10/1095; H04W 4/02

(57) ABSTRACT

A computer implemented system is configured for tracking and alerting selected participants of a scheduled meeting such as a deposition. Scheduled meetings are stored in a database in association with corresponding meeting times, meeting locations, meeting participants, and mobile device numbers of the meeting participants. The system continuously monitors the database to identifying upcoming meetings. Upon a predetermine lead time prior to an upcoming meeting, the system determines an estimated travel time between the present location of the predetermined meeting participant and the meeting location. The system transmits a notification to the predetermined meeting participant when the estimated travel time is within the predetermined lead-time of the meeting unless an appropriate acknowledgement has been received from the meeting participant. The system is configurable to communicate meeting reports and/or documentation associated with the meeting based on transmissions from the wireless device of meeting participant.

### CROSS REFERENCE TO RELATED APPLICATIONS

This application claims the priority of U.S. Provisional Patent Application No. 62/129,173 entitled Deposition Automation System and Method, which was filed on Mar. 6, 2015, and which is incorporated herein by reference in its entirety.

### FIELD OF THE DISCLOSURE

The present disclosure relates to a location based notification and reporting systems, and more particularly to a deposition automation system and method.

### BACKGROUND

Numerous electronic calendars are commonly used in desktop computers, smart phones, tablets and other wireless devices. Commonly, electronic calendars are configurable to provide reminders at selectable times prior to a scheduled event. Various location based applications are also configurable on wireless devices to provide alerts to a user when the device is located at or near a selected geographic location. Other location based applications are available to track vehicles or fleets of vehicles for monitoring by a central dispatcher office, for example. Currently available location based applications are generally not useful for tracking meeting attendees based on a meeting location and automatically managing alerts and communications between meeting attendees.

### SUMMARY

Aspects of the present disclosure include a system and method for communicating to meeting attendees, receiving check-in reports from meeting attendees and alerting one or more of the meeting attendees based on a scheduled meeting time and an estimated travel time between the attendee's location and the scheduled meeting's location. The disclosed system includes a user interface and database for entering, storing and retrieving information about meeting scheduling, attendee contact information. The database is automatically and continuously monitored to identify upcoming meetings and to alert selected attendees based on the attendees travel time and/or travel distance from the meeting location and based on whether the attendee has sent a check-in report acknowledging awareness of the upcoming meeting. The attendee location may be determined based on the location of a mobile device that is associated with the attendee in the database. The mobile device may include location determination circuitry to determine the mobile device's geographic location using one or more known location determination technique such as global positioning system (GPS) location determining techniques and/or cellular communication location determining techniques based on cellular transmissions between the device and known cellular communication antenna locations, for example.

In an illustrative embodiment, the disclosed system and method includes a deposition automation system in which the database includes scheduled depositions and contact information for a court reporter who will be attending the deposition. The system is configured to automatically alert the court reporter if a check-in has not been received from the court reporter acknowledging that the court reporter is aware of an upcoming deposition to which he or she is assigned at a time that is computed based on the travel time between the court reporter's current location and the deposition location. Additional alerts and/or notifications to deposition participants can be configured based on selected check-in reports received from the court reporter's mobile device, or from the mobile device of another deposition participant, for example.

In the illustrative embodiment, the system may also be configured to prompt the court reporter to transmit a deposition summary when the deposition is completed and/or to automatically generate a deposition transcript following the deposition based on information received from the court reporter's mobile device.

### BRIEF DESCRIPTION OF THE DRAWINGS

The following detailed description, given by way of example and not intended to limit the present disclosure solely thereto, will best be appreciated in conjunction with the accompanying drawings in which:

FIG. 1 depicts the structural component of the deposition automation system according to an exemplary embodiment of the present disclosure;

FIGS. 2A and 2B describe the steps of a court reporter process executed by a deposition automation system on the day of a scheduled deposition according to an exemplary embodiment of the present disclosure; and

FIG. 3 describes the steps of a deposition scheduling process executed by the deposition system to schedule a deposition according to an exemplary embodiment of the present disclosure.

FIG. 4 describes a computer implemented method for tracking and alerting meeting participants according to another aspect of the present disclosure.

FIG. 5 describes a computer implemented method for tracking and alerting meeting participants, according to another aspect of the present disclosure.

FIG. 6 describes a system for tracking and notifying meeting participants according to another aspect of the present disclosure.

### DETAILED DESCRIPTION OF THE DISCLOSURE

The present disclosure relates to a deposition automation system and method. While the following description discusses the processes implemented by the deposition automation system in relation to a court reporter or anyone else fulfilling the role of a court reporter that includes, but is not limited to, a steno-mask writer, digital recording technician, note-taker or short-hand writer, it will be apparent to a person of reasonable skill in the art that these processes may be applied to any person involved with a deposition proceeding including but not limited to videographers and interpreters.

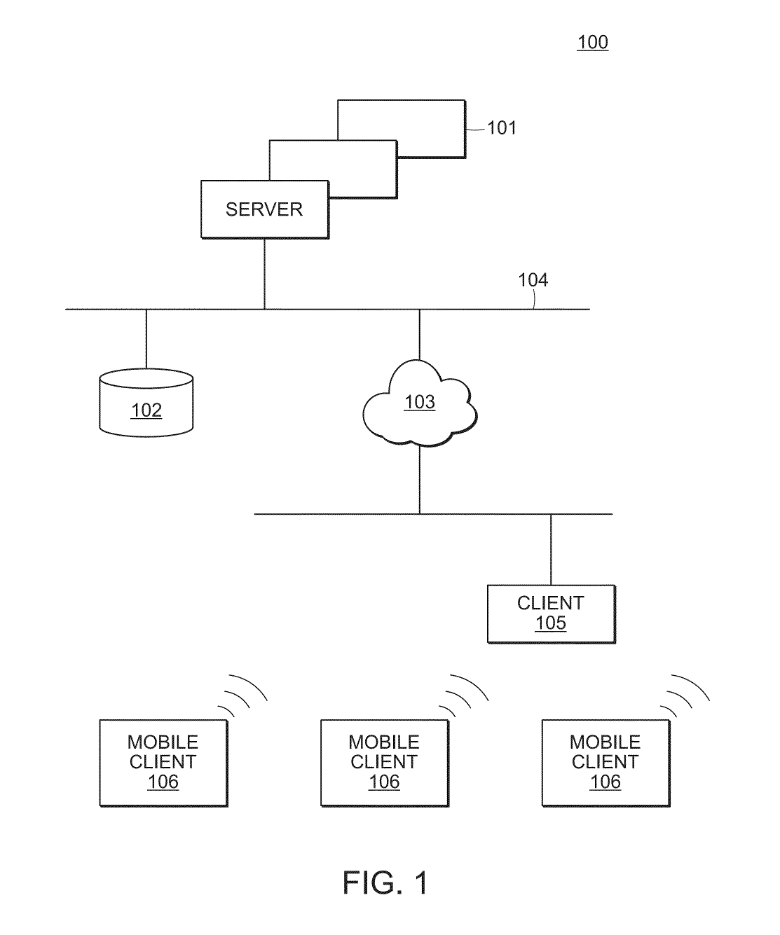

In FIG. 1, the structural component of the deposition automation system according to an exemplary embodiment of the present disclosure is depicted. As shown in FIG. 1, the deposition automation system includes a plurality of servers 101, a database 102, a wide area network (“WAN”) connection 103, a network backbone 104, remote workstation clients 105 and remote mobile clients 105. The network backbone 104 interconnects the servers 101, the database 102 and the wide area network connection 103 using any known transmission protocol such as TCP/IP. The servers 101 may be configured with one or more individual servers which together or individually implement the processes which comprise the deposition automation method of the present disclosure. The database 102 stores and provides access to all data needed to implement the processes which comprise the deposition automation method of the present disclosure. The WAN connection 103 provides the remote workstation clients 105 and the remote mobile clients 106 access to the servers 101 via any know implementation of a secure connection including a firewall, a virtual private network or any other known secure protocol. The workstation clients 105 may implement a specific application to interface with the servers 101 and the processes implemented on those servers 101. Moreover, the workstation clients 105 may interface with the servers 101 via a web browsers which loads a web page hosted on and sever from the servers 101. The workstation clients 105 communicate with the servers 101 using any know internet protocol such as TCP/IP. The mobile clients 105 implements a mobile app which interfaces with the servers 101 using any appropriate internet protocol such at the 802.11 wireless protocol.

On the day before a scheduled or another preset time period prior to the deposition proceeding, the deposition automation system will automatically generate and transmit to all legal representatives participating in that scheduled deposition proceeding a reminder confirmation email. The reminder confirmation email may include the date, time, location, services ordered, and length of the scheduled deposition proceeding as well as a “Confirm” button, a “Modify/Reschedule” button and a “Cancel” button. If the “Confirm” button is actuated, the deposition automation system records this received confirmation and then transmits an acknowledgement email to all participating in the scheduled deposition proceeding.

The “Modify/Reschedule” button when actuated, allows for updating any information relevant to the scheduled deposition proceeding. If the “Modify/Reschedule” button is actuated, the deposition automation system records this received confirmation and then transmits an acknowledgement email to all participating in the scheduled deposition proceeding.

Alternatively, if the “Cancel” button is actuated, the deposition automation system records this received cancellation and removes that scheduled deposition proceeding from an active schedule of scheduled deposition proceedings. The deposition automation system then transmits to all parties participating in the scheduled deposition proceeding an acknowledgement email. The titles of the buttons may change, but the functionality will remain the same.

If, after a predefined period of time, the deposition automation system has not received either a confirmation, modification or a cancellation notice for a scheduled deposition proceeding, the deposition automation system will transit a second reminder email to all legal representatives participating in the scheduled deposition proceeding. The deposition automation system may also, after a predefined period of time, have an automated phone call to the legal representative seeking confirmation. The deposition automation system may also, after a predefined period of time, notify the customer service department so that a live confirmation telephone call can be made.

Upon receiving confirmation of the scheduled deposition proceeding from the legal representatives which scheduled the proceeding, the deposition automation system generates and transmits a notification to the assigned court reporter as well as a confirmation email to the assigned court reporter which includes a “Confirm” button. If the “Confirm” button is actuated, the court reporter electronically confirms their assignment to the scheduled deposition proceeding. Upon receiving the confirmation from the assigned court reporter, the deposition automation system generates and transmits an email to the assigned court reporter that includes information on the scheduled deposition that includes date, time, location with links to directions, who to ask for at the deposition location with links when available to their biographical information, length of deposition, and other specific services ordered and a reminder of the check-in requirements on the day of the deposition proceeding. The deposition automation system also allows for a court reporter to log onto the system to review this information at any time.

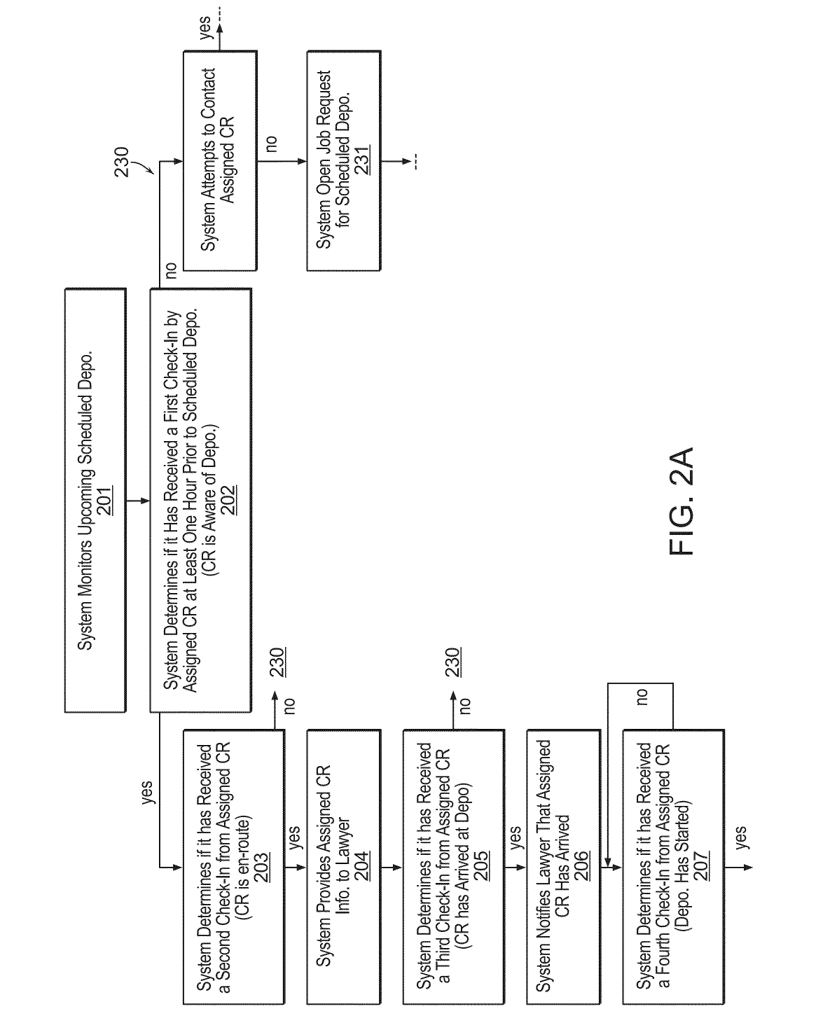

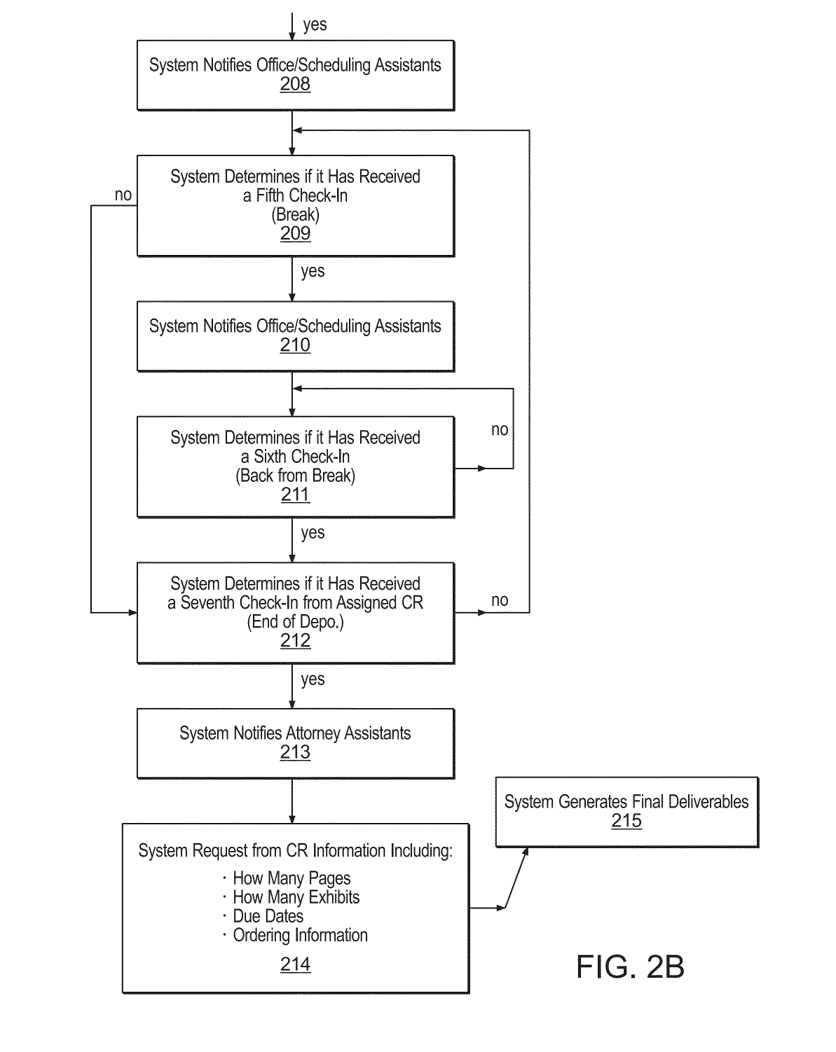

In FIGS. 2A and 2B, the steps of a court reporter process executed by a deposition automation system on the day of a scheduled deposition are described according to an exemplary embodiment of the present disclosure. As shown in FIGS. 2A and 2B, the court reporter process 200 is initiated in step 201 with the deposition automation system monitoring a dynamic listing of deposition proceedings which have been scheduled by registered legal representatives of the deposition automation system. While monitoring the listing of deposition proceedings, the deposition automation system detects and flags those scheduled deposition proceedings whose start date and time is upcoming within a predetermined period of time. Once a scheduled deposition proceeding is detected and flagged, the court reporter process then proceeds to step 202.

In step 202, the deposition automation system determines if it has electronically received a first check-in type from a court reporter currently assigned the flagged deposition proceeding by a predetermined amount of time prior to the required departure time based on a global positioning system that measures time of travel from court reporter's location to the deposition location to arrive at the deposition's start time. A first check-in type provides the deposition automation system with confirmation that the assigned court reporter is aware of the start time for the flagged deposition proceeding to which he is currently assigned. If it is determined that the first check-in type has been received by the predetermined amount of time prior to the required departure time of the flagged deposition proceeding, the court reporter process then proceeds to steps 203. Alternatively, if it is determined that the first check-in type has not been received by the predetermined amount of time prior to the required departure time of the flagged deposition proceeding, the court reporter process then proceeds to step 230.

In step 203, the deposition automation system determines if it has received a second check-in type from the assigned court reporter prior to the start time of the flagged deposition proceeding. The second check-in type provides the deposition automation system with confirmation that the assigned court reporter is en route to the location of the flagged deposition proceeding and will arrive at that location prior to the start time of the flagged deposition proceeding. If the second check-in type has been received prior to the required departure time as relates to the start time of the flagged deposition proceeding, the court reporter process then proceeds to steps 204. Alternatively, if the second check-in type has not been received prior to the required departure time as relates to the start of the flagged deposition proceeding, the court reporter process then proceeds to step 230.

In step 204, the deposition automation system transmits the contact information for the assigned court reporter along with location and start time information for the scheduled deposition proceeding to the legal representatives participating in the flagged deposition proceeding as well as legal representatives who may be tied to the deposition that are not participating at the deposition location.

A “Contact Reporter” button may be included in this transmission which, if activated, provides for contacting the assigned court reporter via email, messaging or phone. According to aspects of the present disclosure, the telephone number and/or other contact information of the court reporter is not disclosed to the other participants in the scheduled deposition.

The legal representatives participating in the flagged deposition proceeding may be defined by the registered user who scheduled the flagged deposition proceeding and may include persons at the physical location of the deposition proceeding as well as person not physically at that location. Moreover, the deposition automation system may be configured to electronically notify third party scheduling and docketing systems which may monitor and document the deposition proceeding. The court reporter process then proceeds to step 205.

In step 205, the deposition automation system determines if it has received a third check-in type from the assigned court reporter prior to the start time of the flagged deposition proceeding. The third check-in type provides the deposition automation system with conformation that the assigned court reported has arrived at the flagged deposition proceeding prior to the start time of that proceeding. If the third check-in type has been received prior to the start time of the flagged deposition proceeding, the deposition process then proceeds to steps 206. Alternatively, if the third check-in type has not been received prior to the start time of the scheduled proceeding, the deposition process then proceeds to step 230. Using GPS information from the court reporter's mobile device, the deposition automation system will estimate at which time the reporter is 5 minutes (or any other appropriate interval that can be selected) away from the deposition site and notify all legal representatives participating in the flagged deposition as well as legal representatives who may be tied to the deposition that are not participating at the deposition location that the reporter is about to arrive at the deposition site.

The deposition automation system can also be set to automatically trigger the reporter check-ins described above using GPS information from the reporter's mobile device where appropriate to indicate that they have (1) started traveling towards the deposition, (2) should be on time, (3) are almost at the deposition site and (3) have arrived.

In step 206, the deposition automation system notifies the legal representatives participating in the flagged deposition as well as legal representatives who may be tied to the deposition that are not participating at the deposition location proceeding that the assigned court reporter has arrived at the proceeding. The court reporter process then proceeds to step 207.

In step 207, the deposition automation system determines if it has received a fourth check-in type from the assigned court reporter. A fourth check-in type provides the deposition automation system with confirmation that the flagged deposition proceeding has actually started and is on the record. If the fourth check-in type has not been received, the deposition automation system presumes that the flagged deposition proceeding has not begun and continues to monitor for confirmation that the proceeding has actually begun and is on the record. The deposition automation system may also allow for the legal representative who scheduled the deposition or customer service to send a notification to the reporter querying whether the deposition has started. If it is confirmed that the flagged deposition proceeding has begun, the deposition automation system records the actual time the flagged deposition proceeding began and the court reporter process then proceeds to step 208.

In step 208, the deposition automation system notifies the legal representatives participating in the flagged deposition proceeding that are off site that the proceeding has actually begun and also provides any other relevant information. The court reporter process then proceeds to step 209.

In step 209, the deposition automation system determines if it has received a fifth check-in type from the court reporter. A fifth check-in type provides the deposition automation system with confirmation that a break has begun in the flagged deposition proceeding. If it is confirmed that a break has begun in the flagged deposition proceeding, the deposition system records the actual time when the break began and entering an estimated length for the break and the court reporter process then proceeds to step 210. Alternative, if it is not confirmed that a break has begun, the court reporter process then proceeds to step 212.

After a break has begun, in step 210, the deposition automation system notifies the legal representatives participating in the flagged deposition proceeding off site that a break has begun and also provides any other relevant information. The court reporter process then proceeds to step 211.

In step 211, the deposition automation system determines if it has received a sixth check-in type from the assigned court reporter. A sixth check-in type provides the deposition automation system with confirmation that a currently ongoing break in the flagged deposition proceeding has ended. If it is confirmed that the currently ongoing break has ended, the deposition automation system records the actual time when the break ended and the court reporter process then proceeds to step 212. Alternatively, if it is not yet confirmed that the currently ongoing break has ended, the deposition automation system continues to monitor for a sixth check-in type from the assigned court reporter. If, after a designated period of time after the estimated break was to conclude, there has not been the sixth check-in, the reporter receives an automatic silent notification reminding them to check back in. The deposition automation system may also allow for the legal representative who scheduled the deposition or customer service to send a notification to the reporter querying whether the recess has ended. The deposition automation system will allow for multiple instances of this sixth check-in to occur. If there has been no break or if a currently ongoing break has ended in the flagged deposition proceeding, in step 212, the deposition automation system determines if it has received a seventh check-in type from the assigned court reporter. A seventh check-in type provides confirmation that the flagged deposition proceeding has ended. If it is confirmed that the flagged disposition proceeding has ended, the deposition automation system records the actual time the proceeding ended and the court reporter process then proceeds to step 213. Alternatively, if it is not yet confirmed that the proceeding has ended, the court reporter process then proceeds back to step 209 and again monitors for a break in the flagged deposition proceeding.

After the deposition has ended, the client application on the reporter's mobile device prompts the reporter to have the attorneys in the room confirm their attendance and transcript order by (1) tapping on the device or (2) making their signature on the device with their finger or (3) confirming with some other action.

In step 213, the deposition automation system notifies the legal representatives participating in the flagged deposition proceeding that the proceeding has ended and also provides any relevant information. The deposition automation system automatically sends out an email, text or application notification to the legal representatives at a designated time after the seventh check-in occurs which includes survey questions that can also include a schema or system whereby the reporter is rated. The court reporter process then proceeds to step 214.

In step 214, the deposition automation system queries the assigned court reporter for any relevant information, including but not limited to the deposition transcript page count, the number of entered exhibits, the legal representatives ordering the deposition transcript, the deposition transcript due dates as well as any other ordering information. It is understood by one of ordinary skill in the art that what defines relevant information may be customized by each registered user. The court reporter process then proceeds to step 215.

In step 215, the deposition system generates a deposition report deliverable for the registered user who schedule the deposition proceeding. Generation of the deposition report may include generation of a deposition transcript using voice recognition software, for example. The deposition report deliverable may be customized by the registered user and may be delivered electronically or in a physical form to the legal representative participating in or related to the flagged deposition proceeding. The deposition report may request confirmation of deliverables and due date via a “Confirm” or “Modify” button. If “Confirm” is selected, the deposition automation system will store this information in its database and alert the production unit of various information. If the “Modify” button is selected, the deposition automation system will allow for the user to change any component of the deliverable or cancel their order. If the “Modify” button is selected, the deposition automation system will notify the court reporter of the modification.

If the deposition automation system has not received either a first check-in type, a second check-in type or a third check-in type, in step 230, the deposition automation system attempts to contact the assigned court reporter. If it is confirmed that the assigned court reporter has been successfully contacted, the deposition automation system queries the assigned court reporter as to his or her status relevant to the flagged deposition proceeding. If possible, the deposition automation system determines whether or not it is possible for the assigned court reporter to reenter the court reporter process at a stage where the assigned court reporter will arrive at the flagged deposition proceeding in time.

This may be accomplished using any means know to one skilled in the art including but not limited to a global tracking system that provides information as to current location of the assigned court reporter and of the travel time necessary to reach the location of the scheduled deposition proceeding.

If it is determined that the assigned court reporter can still reach the deposition proceeding location in time, the deposition automation system reenters the court reporter process at the appropriate check-in stage. Alternatively, if it is determined that the assigned court reporter cannot arrive at the scheduled deposition proceeding in time, the court reporter process then proceeds to step 231.

In step 231, the deposition automation system opens a job request for a new court reporter for the flagged deposition proceeding alerting court reporters who are positioned and available to be able to arrive at the deposition site on time. The deposition automation system also notifies Customer Service of a potential delayed start time. The deposition automation system may also notify the scheduling party of a potential delayed start time.

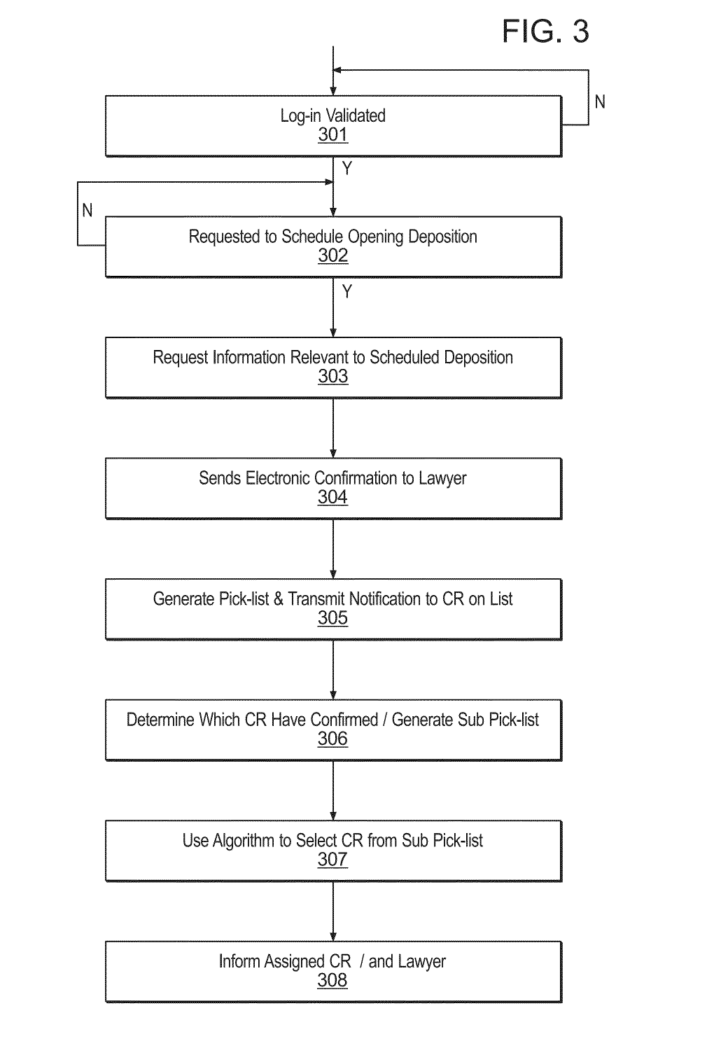

In FIG. 3, the steps of a deposition scheduling process executed by the deposition automation system to schedule a deposition proceeding according to an exemplary embodiment of the present disclosure is described. As shown in FIG. 3, the deposition scheduling process begins with step 301 where the deposition automation system displays a log-in screen which queries a registered user for their username and password. If the entered log-in information is validated, the deposition scheduling process then proceeds to step 302.

Alternatively, if the entered log-in information is not validated, the deposition scheduling process returns to step 301 and the log-in screen is again displayed.

In step 302, the deposition automation system displays a general selection screen and determines if the registered user has requested to schedule an upcoming deposition proceeding. If it is determined that the registered user has requested to schedule an upcoming deposition proceeding, the deposition scheduling process then proceeds to step 303. Alternatively, if it has not been determined that the registered user has requested to schedule an upcoming deposition proceeding, the deposition scheduling process then returns to step 302 and continues to display a general selection screen.

In step 303, the deposition automation system displays a screen which queries the registered user for information relevant to the deposition proceeding to be scheduled. The relevant information may be customized to include any information that will aid in the selection of a court reporter that is most qualified for the scheduled deposition proceeding. In an exemplary embodiment, the relevant information may include case name, deposition type, services requested, required skills and general user preferences. In one embodiment of the present disclosure, court reporters are rated as either standard court reporters or premium court reporters with an algorithm scoring system that the deposition automation system defines and rates. Generally, while all participating court reporters will have been screened and qualified by the deposition automation system, a premium court reporter will have greater skills and experience than a standard court reporter. As such, a premium court reporter may cost more than a standard court reporter and is a court reporter that has an overall satisfaction and deposition automation system compliance rating that is higher than a standard court reporter. Once the deposition automation system has determined that the information necessary to schedule the upcoming deposition proceeding has been received, the deposition scheduling procedure then proceeds to step 304.

In step 304, the deposition automation system schedules the upcoming deposition proceeding and sends a confirmation email to the registered user which includes a detailed description of the services and processes requested that will be implemented for that newly scheduled deposition proceeding. The deposition scheduling process then proceeds to step 305.

In step 305, the deposition automation system generates an initial pick-list of a certain number of qualified court reporters based on the relevant information received from the registered user as well as the scoring algorithm and data stored in its database. The deposition automation system then sends a deposition invitation email to each of the court reporters on that initial pick-list. The deposition scheduling process then proceeds to step 306.

In step 306, the deposition automation system determines which court reporters have responded affirmatively to the electronic deposition invitation. The deposition automation system then generates a final pick-list which includes those qualified court reporters which have confirmed their availability for the scheduled deposition proceeding. The deposition scheduling process then proceeds to step 307.

In step 307, the deposition automation system implements an algorithm based on a series of customizable rules to select which court reporters from the final pick-list will actually be assigned to the scheduled deposition proceeding. These rules may be customized to provide for an effective and adaptable selection process. According to an aspect of the present disclosure, the algorithm may include the use of artificial intelligence methods to develop information with regard to a best choice of court reporter to result in best user satisfaction, for example. These rules may include but are not limited to not selecting a participating court reporter that will be scheduled on a deposition that may conflict with the start time of another deposition; selecting a court reporter near the location of the deposition proceeding; excluding any participating court reporters which have received an adverse rating from any of the legal representatives participating in the scheduled deposition proceeding; selecting only premium court reporters for premium depositions proceedings unless none are available in which case the highest rated standard court reporters are selected; selecting a court reporter that has an earlier/later deposition scheduled nearby that same day; selecting a reporter that has worked on that specific case in the past; selecting a court reporter that has specific technical skills or experience that suit that specific deposition; selecting a reporter that has a rating commensurate with the rating of the legal representative (as been assessed by the deposition automation system based on reporter ratings of the legal representative from earlier depositions); selecting a court reporter based on manual intervention by one of the operators of the deposition automation system; and selecting, if desired, to prioritize premium court reporters for standard depositions proceedings. Once the deposition automation system has selected a court reporter for the scheduled deposition proceeding, the deposition scheduling process then proceeds to step 308.

Lastly, in step 308, the deposition automation system electronically notifies the selected court reporter that he or she has been assigned to the scheduled deposition proceeding.

Moreover, the deposition automation system schedules a notification for the day of the deposition proceeding, which notification would include the name and contact information of the court reporter assigned the scheduled deposition proceeding.

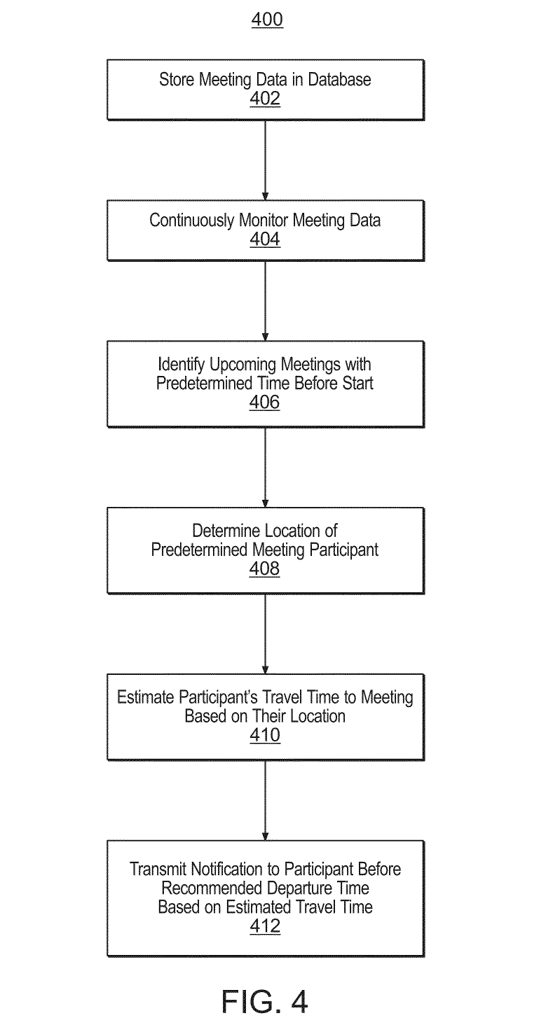

A computer implemented method for tracking and alerting meeting participants according to another aspect of the present disclosure is described with reference to FIG. 4. The computer implemented method 400 includes storing a list of scheduled meetings in a database in association with corresponding meeting times, meeting locations, meeting participants, and mobile device numbers associated with the meeting participants at step 402, and continuously monitoring the list of scheduled meetings at step 404. At stop 406, the method includes identifying a scheduled meeting in the list of scheduled meetings as an upcoming meeting when a current time is within a first predetermined lead-time of a meeting time corresponding to the scheduled meeting. At step 408, the method includes determining a present location of a predetermined meeting participant associated with the upcoming meeting. At step 410, the method includes determining an estimated travel time between the present location of the predetermined meeting participant and the meeting location based on the present location coordinate. And, at step 412, the method includes transmitting a first notification to the predetermined meeting participant when the estimated travel time is within a second predetermined lead-time of the meeting time corresponding to the upcoming meeting.

In an illustrative embodiment, the step of determining the present location of the predetermined meeting participant associated with the upcoming meeting may include transmitting a location request signal to the mobile device number corresponding to the predetermined meeting participant in the database, and receiving a location report signal from the mobile device number corresponding to the predetermined meeting participant in the database. The location report signal may include a present location coordinate automatically generated by a global positioning system receiver in the wireless device in response to the location request signal, for example.

According to an aspect of the present disclosure, the step of determining the estimated travel time between the present location of the predetermined meeting participant and the meeting location may include executing a routing algorithm based on the present location of the predetermined meeting participant and the meeting location. The step of determining the estimated travel time between the present location of the predetermined meeting participant and the meeting location may also include transmitting a request for current traffic information between the present location of the predetermined meeting participant and the meeting location, receiving a current traffic information report and executing the routing algorithm based on the current traffic information.

Alternatively, the step of determining the estimated travel time between the present location of the predetermined meeting participant and the meeting location may include transmitting a travel time request to a routing engine and receiving a travel time report from the routing engine in response to the travel time request. The travel time request may include the present location of the predetermined meeting participant and the meeting location, for example.

According to aspects of the present disclosure, the meeting may be a deposition, and the predetermined meeting participant may be a court reporter, for example. According to this aspect, the computer implemented method may also include receiving a meeting summary report from the court reporter, and automatically generating a meeting transcription document in response to receiving the meeting summary report. The meeting summary report may include a number of pages in a transcript of the deposition, and a number exhibits, for example.

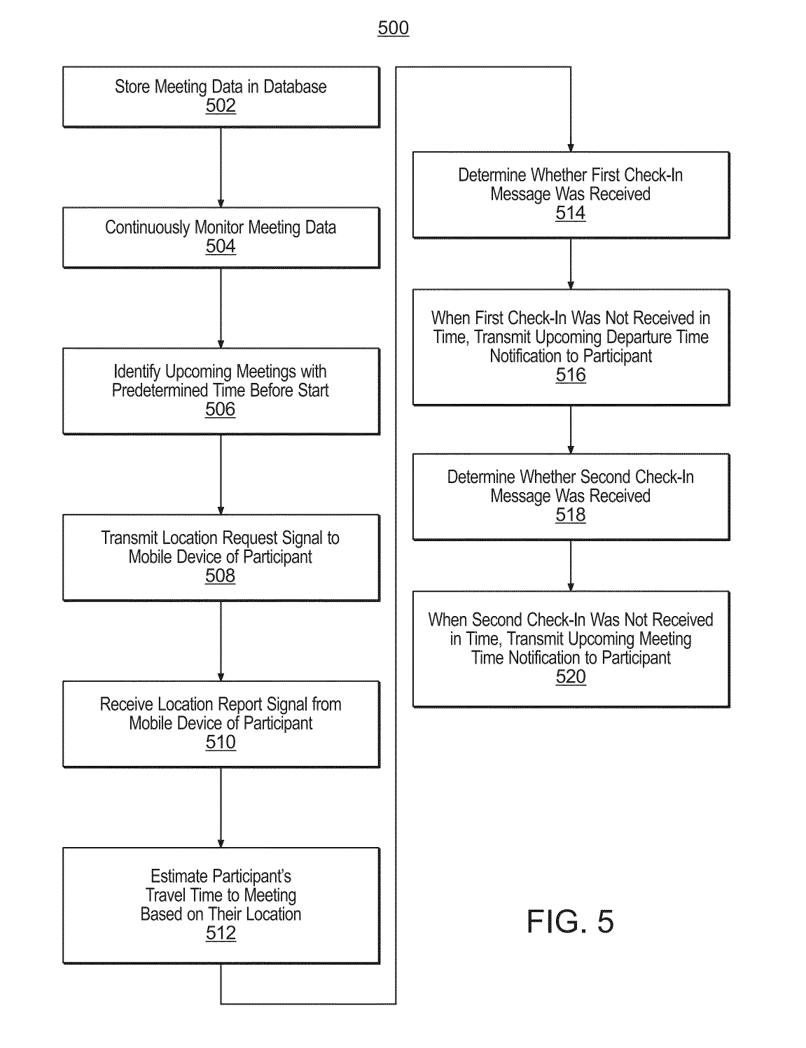

A computer implemented method for tracking and alerting meeting participants, according to another aspect of the present disclosure is described with reference to FIG. 5. The method 500 includes storing a list of scheduled meetings in a database in association with corresponding meeting times, meeting locations, meeting participants, and mobile device numbers associated with the meeting participants at step 502, and continuously monitoring the list of scheduled meetings at step 504. At step 506, the method also includes identifying a scheduled meeting in the list of scheduled meetings as an upcoming meeting when a current time is within a first predetermined lead-time of a meeting time corresponding to the scheduled meeting.

At step 508, the method includes transmitting a location request signal to the mobile device number corresponding to the predetermined meeting participant in the database. At step 510, the method includes receiving a location report signal from the mobile device number corresponding to the predetermined meeting participant in the database. The location report signal may include a present location coordinate automatically generated by a global positioning system receiver in the wireless device in response to the location request signal, for example. At step 512, the method includes determining an estimated travel time between the present location of the predetermined meeting participant and the meeting location based on the present location coordinate.

At step 514, the method includes determining whether, at a second pre-determined lead time greater than the estimated travel time prior to the meeting time corresponding to the upcoming meeting, a first check-in message from the predetermined meeting participant has been received indicating that the predetermined meeting participant is aware of upcoming meeting. At step 516 in response to determining whether the first check-in message has been received, when the first check-in message has not been received by the second predetermined lead time, the method includes transmitting a first notification to the predetermined meeting participant when the estimated travel time is within the second predetermined lead-time of the meeting time corresponding to the upcoming meeting.

According to this aspect of the present disclosure, at step 518, the method may also include determining whether, at the estimated travel time prior to the meeting time corresponding to the upcoming meeting, a second check-in message from the predetermined meeting participant has been received indicating that the predetermined meeting participant is en route to the upcoming meeting. In response to determining whether the second check-in message has been received, when the second check-in message has not been received by the estimated travel time prior to the meeting time, the method includes transmitting a second notification to the predetermined meeting participant at the estimated travel time prior to the meeting time corresponding to the upcoming meeting at step 520.

According to this aspect of the present disclosure, the method may also include receiving a third check-in message from the predetermined meeting participant indicating that participant has arrived at the meeting location, and in response to receiving the third check-in message, notifying a second meeting participant that the predetermined meeting participant has arrived. The method may also include receiving a fourth check-in message from the predetermined meeting participant indicating that meeting has begun, and in response to receiving the fourth check-in message, notifying a predetermined scheduling assistant, who is associated with the meeting in the database, that the meeting has begun.

The method may also include receiving fifth check-in message from the predetermined meeting participant indicating that break has begun, and in response to receiving the fifth check-in message, notifying a predetermined scheduling assistant, who is associated with the meeting in the database, that the meeting break has begun. The method may further include receiving a sixth check-in message from the predetermined meeting participant indicating that the meeting break has ended, and in response to receiving the sixth check-in message, notifying the predetermined scheduling assistant that the meeting break has ended, for example.

According to this aspect of the present disclosure, the method may also include receiving a seventh check-in message from the predetermined meeting participant indicating that meeting has ended, and in response to receiving the seventh check-in message, transmitting a meeting summary request to the predetermined meeting participant.

In one example implementation the meeting may be a deposition, and the predetermined meeting participant may be a court reporter, for example. In this implementation, the method may further include receiving a meeting summary report from the court reporter, and automatically generating a meeting transcription document in response to receiving the meeting summary report. The meeting summary request comprises a number of pages in a transcript of the deposition, a number exhibits, for example.

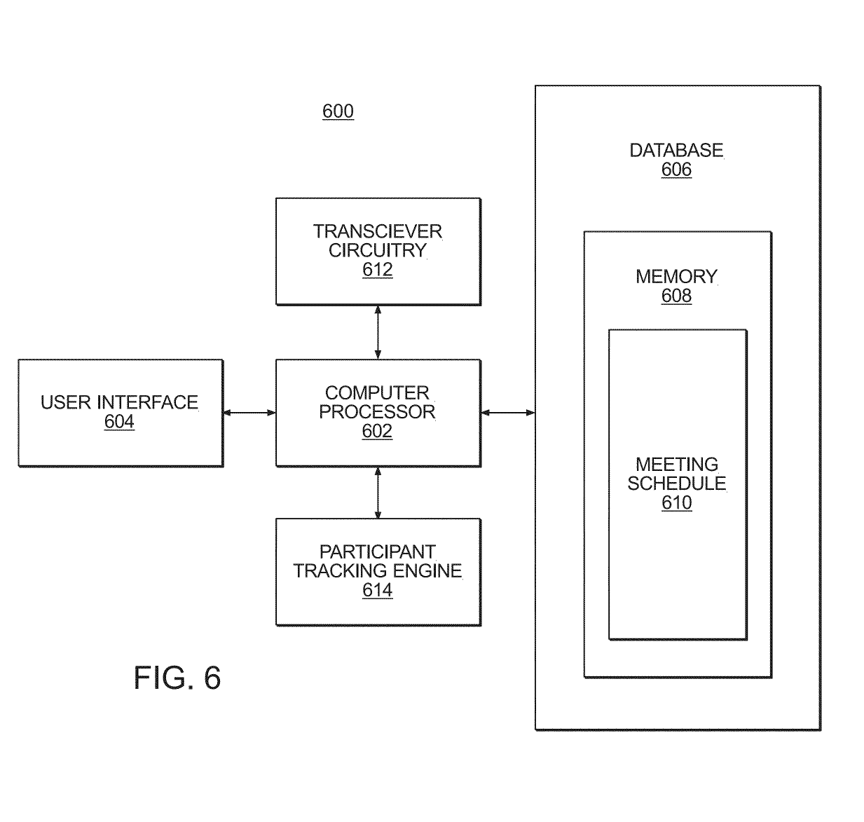

A system for tracking and notifying meeting participants according to another aspect of the present disclosure is described with reference to FIG. 6. The system 600 includes a computer processor 602 operatively coupled to a user interface 604. A database 606 is coupled in communication with the computer processor 602. The database 606 includes memory 608 storing a meeting schedule 610. The meeting schedule 610 includes a meeting time, a meeting geographical location, and a listing of one or more meeting participants for each of a plurality of meetings, for example. The system 600 also includes wireless transceiver circuitry 612 coupled in electronic communication with the computer processor 602 and a participant tracking engine 614 executing on the computer processor 602.

The participant tracking engine 614 is configured to store a list of scheduled meetings in the database in association with corresponding meeting times, meeting locations, meeting participants, and mobile device numbers associated with the meeting participants. This information may be entered to the database 606 via the user interface 604 and/or via the wireless transceiver circuitry 612, for example. The participant tracking engine 614 is further configured to continuously monitor the list of scheduled meetings and to identify a scheduled meeting in the list of scheduled meetings as an upcoming meeting when a current time is within a first predetermined lead-time of a meeting time corresponding to the scheduled meeting.

The participant tracking engine 614 is further configured to determine a present location of a predetermined meeting participant associated with the upcoming meeting and to determine an estimated travel time between the present location of the predetermined meeting participant and the meeting location based on the present location coordinate. According to an aspect of the present disclosure, the participant tracking engine 614 is further configured to transmit a first notification to the predetermined meeting participant via the wireless transceiver circuitry 612 when the estimated travel time is within a second predetermined lead-time of the meeting time corresponding to the upcoming meeting.

According to an aspect of the present disclosure, the participant tracking engine 614 is further configured to transmit a location request signal to the mobile device number corresponding to the predetermined meeting participant in the database via the wireless transceiver circuitry 612. The participant tracking engine 614 is configured to then receive a location report signal from the mobile device number corresponding to the predetermined meeting participant in the database via the wireless transceiver circuitry. The location report signal may include a present location coordinate automatically generated by a global positioning system receiver in the wireless device in response to the location request signal, for example. The participant tracking engine 614 may determining the estimated travel time between the present location of the predetermined meeting participant and the meeting location by executing a routing algorithm based on the present location of the predetermined meeting participant and the meeting location, for example. The participant tracking engine 614 may also transmit a request for current traffic information between the present location of the predetermined meeting participant and the meeting location, receive a current traffic information report, and execute the routing algorithm based on the current traffic information.

Alternatively, the participant tracking engine 614 may determine the estimated travel time between the present location of the predetermined meeting participant and the meeting location by transmitting a travel time request to a routing engine, and receiving a travel time report from the routing engine in response to the travel time request. The travel time request may include the present location of the predetermined meeting participant and the meeting location, for example.

According to an aspect of the present disclosure, the meeting may be a deposition, and the predetermined meeting participant may be a court reporter, for example. According to this aspect, the participant tracking engine 614 is further configured to receive a meeting summary report from the court reporter via the wireless transceiver circuitry, and automatically generate a meeting transcription document in response to receiving the meeting summary report. The meeting summary request may include a number of pages in a transcript of the deposition, and a number exhibits, for example.

According to another aspect of the present disclosure, a non-transitory computer-readable medium includes program code embedded thereon. The program code is executable in a computer system to perform steps of storing a list of scheduled meetings in a database in association with corresponding meeting times, meeting locations, meeting participants, and mobile device numbers associated with the meeting participants and continuously monitoring the list of scheduled meetings.

According to this aspect of the present disclosure, the program code is executable in the computer system to perform additional steps of identifying a scheduled meeting in the list of scheduled meetings as an upcoming meeting when a current time is within a first predetermined lead-time of a meeting time corresponding to the scheduled meeting, determining a present location of a predetermined meeting participant associated with the upcoming meeting, and determining an estimated travel time between the present location of the predetermined meeting participant and the meeting location based on the present location coordinate. The program code is also executable in the computer system to perform steps of transmitting a first notification to the predetermined meeting participant when the estimated travel time is within a second predetermined lead-time of the meeting time corresponding to the upcoming meeting.

According to another aspect of the present disclosure, a computer implemented method for tracking meeting participants is executable on a mobile device. The method includes receiving a first notification by the mobile device associated with a predetermined meeting participant in a database when an estimated travel time between a location of the mobile device and the meeting is within a predetermined lead-time of a meeting time corresponding to an upcoming meeting in the database. The method includes receiving a location request signal by the mobile device and transmitting a location report signal from the mobile device in response to the location request signal. The location report signal may include a present location coordinate automatically generated by a global positioning system receiver in the mobile device, for example.

In an example implementation, the meeting may be a deposition, and the predetermined meeting participant may be a court reporter, for example. In this implementation, the method may further include transmitting a meeting summary report from the mobile device, and receiving an automatically generating a meeting transcription document by the mobile device in response to transmitting the meeting summary report. The meeting summary request may include a number of pages in a transcript of the deposition, and a number exhibits, for example.

The present disclosure also implements a court reporter rating system which aids in the selection of a court reporter for a scheduled deposition proceeding. A base rating for a court reporter is established using feedback from clients, legal representatives or any other persons who may have worked with the court reporter. At the ends of each deposition proceeding, the deposition automation system electronically queries the legal representative participating in the deposition proceeding for feedback on the assigned court reporter as well as a base rating of that court reporter. The requested feedback may be in the form of questions concerning the assigned court reporter including but not limited to would you want to use the assigned court reporter again?; was the reporter polite, on time, courteous and well presented?; was the court reporter a good match for the deposition proceeding?; would you like to have the court reporter for the duration of the case?; would you like the court reporter for future depositions in another case? If the location of the deposition was not provided by the legal representative and was a location provided by the deposition automation system, a query to the legal representatives attending the deposition would be included to rate the conference room.

This data would be collected and rooms with a score below a certain level would be removed from the list of available conference rooms.

The answers to these questions and any other feedback provided by legal representatives is stored by the deposition automation system and used in an algorithm to aid in establishing a base rating for the court reporter. Moreover, this same feedback will be used to establish a preference for this court reporter for future deposition proceedings in the same case, for the same attorney or for the same firm as well as impacting compensation to the court reporter. However, this same feedback may also be used to establish an aversion to the court reporter and thereby ensure that this court reporter is not assigned to future deposition proceedings in the same case, for the same attorney or for the same firm.

Once a base rating for a court reporter has been established, the deposition automation system may then adjust that base rating using non-client information. The non-client information may include information on whether or not the court reporter submitted a rough draft of the deposition transcript within a predetermined amount of time from the completion of the deposition proceeding; the actual time it took the court reporter to submit a rough draft of the deposition; submitted a final draft of the transcript within a defined period from the completion of the deposition proceeding; sent any exhibits from the deposition proceeding to a deposition system receiving center within a defined period from the completion of the deposition proceeding; how long it took for the court reporter to send any exhibits from the deposition proceeding to a deposition system receiving center; the amount and extent of any customer service queries that have resulted from depositions performed by this reporter and whether they directly/indirectly related to the court reporter, or not at all; accurately transcribed the deposition proceeding based on feedback from legal representatives who have reviewed the transcripts or from any other quality review that has been performed on the transcript; and has provided timely feedback to the deposition automation system via a series of electronic check-ins as part of the court reporter process implemented in conjunction with a deposition proceeding. The automated deposition system may take into account other questions and data points that would impact and affect the overall customer experience.

The deposition system implements a court reporter rating methodology which is dynamic and continually adjusted. Court reporters are regularly notified of and have the ability to log in to the deposition automation system to see their current rating along with commentary as to factors which have caused their rating to change. The commentary may also include guidance on how the court reporter may increase his or her rating.

At the ends of each deposition proceeding, the deposition automation system electronically queries the court reporter assigned to a deposition proceeding for feedback on the legal representatives participating in that deposition proceeding as well as a base rating of those legal representatives. The requested feedback may be in a form of question concerning the legal representatives, these question including but not limited to was the attorney easy to understand, polite and on timely?; and did the attorney have an accent? The deposition automation system records these ratings in its database and using an algorithm generates a rating for each legal representative that is included in the overall algorithm that selects court reporters for depositions. Generally, higher rated legal representatives are allocated higher rated reporters.

What is claimed is:

1. A computer implemented method for tracking and alerting meeting participants, comprising:
storing a list of scheduled meetings in a database in association with corresponding meeting times, meeting locations, meeting participants, and mobile device numbers associated with the meeting participants;
continuously monitoring the list of scheduled meetings;
identifying a scheduled meeting in the list of scheduled meetings as an upcoming meeting when a current time is within a first predetermined lead-time of a meeting time corresponding to the scheduled meeting;
determining a present location of a predetermined meeting participant associated with the upcoming meeting;
determining an estimated travel time between the present location of the predetermined meeting participant and the meeting location based on the present location coordinate; and
transmitting a first notification to the predetermined meeting participant when the estimated travel time is within a second predetermined lead-time of the meeting time corresponding to the upcoming meeting.

2. The method of claim 1, wherein determining the present location of the predetermined meeting participant associated with the upcoming meeting comprises:
transmitting a location request signal to the mobile device number corresponding to the predetermined meeting participant in the database; and
receiving a location report signal from the mobile device number corresponding to the predetermined meeting participant in the database, wherein the location report signal comprises a present location coordinate automatically generated by a global positioning system receiver in the wireless device in response to the location request signal.

3. The method of claim 1, wherein determining the estimated travel time between the present location of the predetermined meeting participant and the meeting location comprises:
executing a routing algorithm based on the present location of the predetermined meeting participant and the meeting location.

4. The method of claim 3, wherein determining the estimated travel time between the present location of the predetermined meeting participant and the meeting location further comprises:
transmitting a request for current traffic information between the present location of the predetermined meeting participant and the meeting location;
receiving a current traffic information report; and
executing the routing algorithm based on the current traffic information.

5. The method of claim 1, wherein determining the estimated travel time between the present location of the predetermined meeting participant and the meeting location comprises:
transmitting a travel time request to a routing engine, the travel time request including the present location of the predetermined meeting participant and the meeting location; and
receiving a travel time report from the routing engine in response to the travel time request.

6. The method of claim 1, wherein the meeting comprises a deposition, and wherein the predetermined meeting participant is a court reporter.

7. The method of claim 6, further comprising:
receiving a meeting summary report from the court reporter, wherein the meeting summary request comprises a number of pages in a transcript of the deposition, a number exhibits; and
automatically generating a meeting transcription document in response to receiving the meeting summary report.

8. A computer implemented method for tracking and alerting meeting participants, comprising:
storing a list of scheduled meetings in a database in association with corresponding meeting times, meeting locations, meeting participants, and mobile device numbers associated with the meeting participants;
continuously monitoring the list of scheduled meetings;
identifying a scheduled meeting in the list of scheduled meetings as an upcoming meeting when a current time is within a first predetermined lead-time of a meeting time corresponding to the scheduled meeting;
transmitting a location request signal to the mobile device number corresponding to the predetermined meeting participant in the database; and
receiving a location report signal from the mobile device number corresponding to the predetermined meeting participant in the database, wherein the location report signal comprises a present location coordinate automatically generated by a global positioning system receiver in the wireless device in response to the location request signal;
determining an estimated travel time between the present location of the predetermined meeting participant and the meeting location based on the present location coordinate;
determining whether, at a second pre-determined lead time greater than the estimated travel time prior to the meeting time corresponding to the upcoming meeting, a first check-in message from the predetermined meeting participant has been received indicating that the predetermined meeting participant is aware of upcoming meeting; and
in response to determining whether the first check-in message has been received, when the first check-in message has not been received by the second predetermined lead time, transmitting a first notification to the predetermined meeting participant when the estimated travel time is within the second predetermined lead-time of the meeting time corresponding to the upcoming meeting.

9. The method of claim 8, further comprising:
determining whether, at the estimated travel time prior to the meeting time corresponding to the upcoming meeting, a second check-in message from the predetermined meeting participant has been received indicating that the predetermined meeting participant is en route to the upcoming meeting; and
in response to determining whether the second check-in message has been received, when the second check-in message has not been received by the estimated travel time prior to the meeting time, transmitting a second notification to the predetermined meeting participant at the estimated travel time prior to the meeting time corresponding to the upcoming meeting.

10. The method of claim 8, further comprising:
receiving a third check-in message from the predetermined meeting participant indicating that participant has arrived at the meeting location; and
in response to receiving the third check-in message, notifying a second meeting participant that the predetermined meeting participant has arrived.

11. The method of claim 8, further comprising:
receiving a fourth check-in message from the predetermined meeting participant indicating that meeting has begun; and
in response to receiving the fourth check-in message, notifying a predetermined scheduling assistant, who is associated with the meeting in the database, that the meeting has begun.

12. The method of claim 8, further comprising:
receiving fifth check-in message from the predetermined meeting participant indicating that break has begun; and
in response to receiving the fifth check-in message, notifying a predetermined scheduling assistant, who is associated with the meeting in the database, that the meeting break has begun.
receiving a sixth check-in message from the predetermined meeting participant indicating that the meeting break has ended; and
in response to receiving the sixth check-in message, notifying the predetermined scheduling assistant that the meeting break has ended.

13. The method of claim 8, further comprising:
receiving a seventh check-in message from the predetermined meeting participant indicating that meeting has ended; and
in response to receiving the seventh check-in message, transmitting a meeting summary request to the predetermined meeting participant.

14. The method of claim 1, wherein the meeting comprises a deposition, and wherein the predetermined meeting participant is a court reporter.

15. The method of claim 14, further comprising:
receiving a meeting summary report from the court reporter, wherein the meeting summary request comprises a number of pages in a transcript of the deposition, a number exhibits; and
automatically generating a meeting transcription document in response to receiving the meeting summary report.

16. A system comprising:
a computer processor operatively coupled to a user interface;
a database in communication with the computer processor, the database comprising memory storing a meeting schedule, the meeting schedule comprising a meeting time, a meeting geographical location, and a listing of one or more meeting participants for each of a plurality of meetings;
wireless transceiver circuitry coupled in electronic communication with the computer processor; and
a participant tracking engine executing on the computer processor, the participant tracking engine configured to:
store a list of scheduled meetings in the database in association with corresponding meeting times, meeting locations, meeting participants, and mobile device numbers associated with the meeting participants;
continuously monitor the list of scheduled meetings;
identify a scheduled meeting in the list of scheduled meetings as an upcoming meeting when a current time is within a first predetermined lead-time of a meeting time corresponding to the scheduled meeting;
determine a present location of a predetermined meeting participant associated with the upcoming meeting;
determine an estimated travel time between the present location of the predetermined meeting participant and the meeting location based on the present location coordinate; and
transmit a first notification to the predetermined meeting participant via the wireless transceiver circuitry when the estimated travel time is within a second predetermined lead-time of the meeting time corresponding to the upcoming meeting.

17. The system of claim 16, wherein the participant tracking engine is further configured to:
transmit a location request signal to the mobile device number corresponding to the predetermined meeting participant in the database via the wireless transceiver circuitry; and
receive a location report signal from the mobile device number corresponding to the predetermined meeting participant in the database via the wireless transceiver circuitry, wherein the location report signal comprises a present location coordinate automatically generated by a global positioning system receiver in the wireless device in response to the location request signal.

18. The system of claim 16, wherein determining the estimated travel time between the present location of the predetermined meeting participant and the meeting location comprises:
executing a routing algorithm based on the present location of the predetermined meeting participant and the meeting location.

19. The system of claim 18, wherein determining the estimated travel time between the present location of the predetermined meeting participant and the meeting location further comprises:
transmitting a request for current traffic information between the present location of the predetermined meeting participant and the meeting location;
receiving a current traffic information report; and
executing the routing algorithm based on the current traffic information.

20. The system of claim 16, wherein determining the estimated travel time between the present location of the predetermined meeting participant and the meeting location comprises:
transmitting a travel time request to a routing engine, the travel time request including the present location of the predetermined meeting participant and the meeting location; and
receiving a travel time report from the routing engine in response to the travel time request.

21. The system of claim 16, wherein the meeting comprises a deposition, and wherein the predetermined meeting participant is a court reporter.

22. The system of claim 6, wherein the participant tracking engine is further configured to:
receive a meeting summary report from the court reporter via the wireless transceiver circuitry, wherein the meeting summary request comprises a number of pages in a transcript of the deposition, a number exhibits; and
automatically generate a meeting transcription document in response to receiving the meeting summary report.

23. A non-transitory computer-readable medium having program code embedded thereon, the program code executable in a computer system to perform a method comprising:
storing a list of scheduled meetings in a database in association with corresponding meeting times, meeting locations, meeting participants, and mobile device numbers associated with the meeting participants;
continuously monitoring the list of scheduled meetings;
identifying a scheduled meeting in the list of scheduled meetings as an upcoming meeting when a current time is within a first predetermined lead-time of a meeting time corresponding to the scheduled meeting;
determining a present location of a predetermined meeting participant associated with the upcoming meeting;
determining an estimated travel time between the present location of the predetermined meeting participant and the meeting location based on the present location coordinate; and
transmitting a first notification to the predetermined meeting participant when the estimated travel time is within a second predetermined lead-time of the meeting time corresponding to the upcoming meeting

24. A computer implemented method executable on a mobile device for tracking meeting participants, the method comprising:
receiving a first notification by a mobile device associated with a predetermined meeting participant in a database when an estimated travel time between a location of the mobile device and the meeting is within a predetermined lead-time of a meeting time corresponding to an upcoming meeting in the database;
receiving a location request signal by the mobile device; and
transmitting a location report signal from the mobile device in response to the location request signal, wherein the location report signal comprises a present location coordinate automatically generated by a global positioning system receiver in the mobile device.

25. The method of claim 24, wherein the meeting comprises a deposition, and wherein the predetermined meeting participant is a court reporter, the method further comprising:
transmitting a meeting summary report from the mobile device, wherein the meeting summary request comprises a number of pages in a transcript of the deposition, a number exhibits; and
receiving an automatically generating a meeting transcription document by the mobile device in response to transmitting the meeting summary report.
